(19) United States
(12) Patent Application Publication
(10) Pub. No.: US 2011/0215515 A1
(43) Pub. Date: Sep. 8, 2011

(54) SHEET FINISHING APPARATUS AND SHEET FINISHING METHOD

(75) Inventors: Naofumi Soga, Shizuoka-ken (JP); Shoichi Dobashi, Shizuoka-ken (JP)

(73) Assignees: Kabushiki Kaisha Toshiba, Tokyo (JP); Toshiba Tec Kabushiki Kaisha, Tokyo (JP)

(21) Appl. No.: 13/041,186

(22) Filed: Mar. 4, 2011

Related U.S. Application Data
(60) Provisional application No. 61/311,242, filed on Mar. 5, 2010.
(60) Provisional application No. 61/311,253, filed on Mar. 5, 2010.

(51) Int. Cl. B41L 43/12; B65H 9/00

(52) U.S. Cl. 270/58.08; 270/58.27

(57) ABSTRACT

A sheet finishing apparatus according to an embodiment includes a discharge opening from which a sheet is discharged in an operation mode other than a manual stapling mode, and through which a bundle of sheets is manually inserted inside the discharge opening in the manual stapling mode, a stapler that is disposed inside the discharge opening and binds the bundle of sheets inserted from the discharge opening with staples, and a transverse alignment plate that aligns the sheet discharged from the discharge opening in a sheet discharge direction in the operation mode other than the manual stapling mode, and guides the bundle of sheets inserted from the discharge opening to a position of the stapler in the manual stapling mode. The transverse alignment plate emits light or exhibits fluorescence.

### CROSS-REFERENCE TO RELATED APPLICATIONS

This application is based upon and claims the benefit of priority from: U.S. provisional applications 61/311,253 filed on Mar. 5, 2010, and 61/311,242 filed on Mar. 5, 2010, the entire contents of each of which are incorporated herein by reference.

### FIELD

Embodiments described herein relate generally to a sheet finishing apparatus and an image forming apparatus.

### BACKGROUND

Typically, a sheet finishing apparatus is known which is installed on the downstream side of an image forming apparatus such as a copying machine, a printer, or a multi-functional peripheral (MFP) and performs finishing, such as sorting or stapling, on a printed sheet.

Such kind of sheet finishing apparatus may include a manual stapling mode. The manual stapling mode is an operation mode in which a user manually inserts a bundle of sheets through the sheet discharge opening of the sheet finishing apparatus and thereafter, when the user presses a staple button, a stapler included in the sheet finishing apparatus binds one corner of the bundle of sheets. In the manual stapling mode, as long as the user inserts the bundle of sheets to the position of the stapler inside the discharge opening, thereafter, the bundle of sheets is bound by the force of the stapler itself without the user adding force. Accordingly, even a relatively thick bundle of sheets can be simply and quickly bound.

However, in general, it is difficult for light to travel to the inside of the discharge opening of the sheet finishing apparatus. Particularly, recently, for the purpose of energy saving or the like, there are more and more situations where unnecessary lighting is discouraged on work in the office, so that there is a high possibility that insufficient brightness is ensured at the inside of the discharge opening of the sheet finishing apparatus and thus the inside of the discharge opening is typically dark. Accordingly, even though the user tries to insert the bundle of sheets to the inside of the discharge opening and align the corner of the bundle of sheets with the position of the stapler, accurate position alignment cannot be achieved. In addition, before the user is accustomed to using the machine, there are possibilities that the user cannot perform stapling at all or makes mistakes in stapling, such as stapling at an unintended position.

Therefore, a sheet finishing apparatus which, even when ambient lighting is dark, can reduce mistakes in stapling and enhance operability of the manual stapling mode is desired.

On the other hand, in the manual stapling mode according to the related art, in most cases, binding one point of one corner of the bundle of sheets with staples, so called “one-point binding” is performed. Binding two points near the center of one side of the bundle of sheets with staples, so-called “two-point binding” is studied. However, only one size of sheet can have two-point binding applied and, for example, is limited to A4 size.

Therefore, a sheet finishing apparatus capable of performing the two-point binding on a bundle of sheets with various sheet sizes in the manual stapling mode is desired.

### DESCRIPTION OF THE DRAWINGS

FIG. 1 is a perspective view illustrating an example of the outer appearances of a sheet finishing apparatus and an image forming apparatus according to an embodiment.

FIG. 2 is a first enlarged view of the upper part of the sheet finishing apparatus.

FIG. 3 is a second enlarged view of the upper part of the sheet finishing apparatus.

FIG. 4 is a cross-sectional view illustrating an example of the configuration of the sheet finishing apparatus.

FIG. 5 is a diagram illustrating positions of a standby tray and a processing tray.

FIG. 6 is a diagram illustrating an example of the configuration of the processing tray in detail.

FIG. 7 is a diagram showing a workflow of a sheet when a fixed tray (simple stacking mode) is selected.

FIG. 8 is a diagram showing a workflow of a sheet when a movable tray (simple stacking mode) is selected.

FIG. 9 is a diagram showing a workflow of a sheet when a processing stacking mode (staking in the movable tray) is selected.

FIGS. 10A to 10D are diagrams for explaining operations of causing a sheet to fall down from the standby tray to the processing tray.

FIG. 11 is a diagram for explaining operations of longitudinal alignment and transverse alignment.

FIGS. 12A to 12C are diagrams for explaining an operation of one-point binding using a stapler.

FIGS. 13A to 13C are diagrams for explaining an operation of two-point binding using a stapler.

FIG. 14 is a diagram illustrating a display example used in a manual stapling mode.

FIG. 15 is a diagram illustrating an insertion direction of a bundle of sheets in a manual stapling mode.

FIG. 16 is a diagram illustrating a transverse alignment plate (first example) of a sheet finishing apparatus according to a first embodiment.

FIG. 17 is a diagram illustrating the transverse alignment plate (second example) of the sheet finishing apparatus according to the first embodiment.

FIG. 18 is a diagram showing a state where a bundle of sheets is inserted into the sheet finishing apparatus according to the first embodiment.

FIG. 19 is a first diagram showing an example of a position detecting unit of a transverse alignment plate in a sheet finishing apparatus according to a second embodiment.

FIG. 20 is a second diagram showing the example of the position detecting unit of the transverse alignment plate in the sheet finishing apparatus according to the second embodiment.

### DETAILED DESCRIPTION

Embodiments of a sheet finishing apparatus and an image forming apparatus will be described with reference to the accompanying drawings.

The sheet finishing apparatus according to an embodiment includes a discharge opening from which a sheet is discharged in an operation mode other than a manual stapling mode, and through which a bundle of sheets is manually inserted inside the discharge opening in the manual stapling mode, a stapler that is disposed inside the discharge opening and binds the bundle of sheets inserted from the discharge opening with staples, and a transverse alignment plate that aligns the sheet discharged from the discharge opening in a sheet discharge direction in the operation mode other than the manual stapling mode, and guides the bundle of sheets inserted from the discharge opening to a position of the stapler in the manual stapling mode. The transverse alignment plate emits light or exhibits fluorescence.

### (1) Configuration

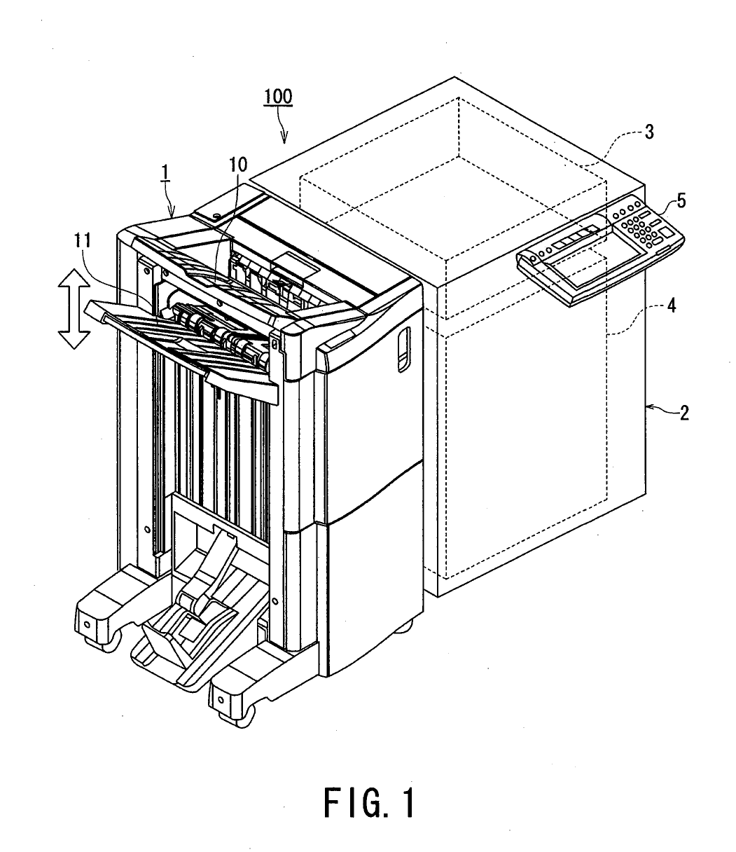

FIG. 1 is a perspective view illustrating an example of the outer appearance of the basic configuration of an image forming apparatus 100 including a sheet finishing apparatus 1 according to a first embodiment. The image forming apparatus 100 has an image forming apparatus main body 2 and the sheet finishing apparatus 1 disposed adjacent to the main body 2.

The main body 2 includes a scanner 3 that reads out an original document, and a printer 4 that prints an image read out by the scanner 3 on a sheet. The main body 2 also includes a control panel 5 having a display panel and various operating keys.

The sheet finishing apparatus 1 includes a fixed tray 10 in which sheets printed by the main body 2 and then discharged are stacked, and a movable tray 11 which is movable in a vertical direction as indicated by the arrow and in which a large amount of printed sheets are stacked. The sheet finishing apparatus 1 has, in addition to typical operation modes having a function of sorting a plurality of printed sheets (a bundle of sheets) and a function of binding them with staples, a manual stapling mode for manually stapling the bundle of sheets by an operation of a user.

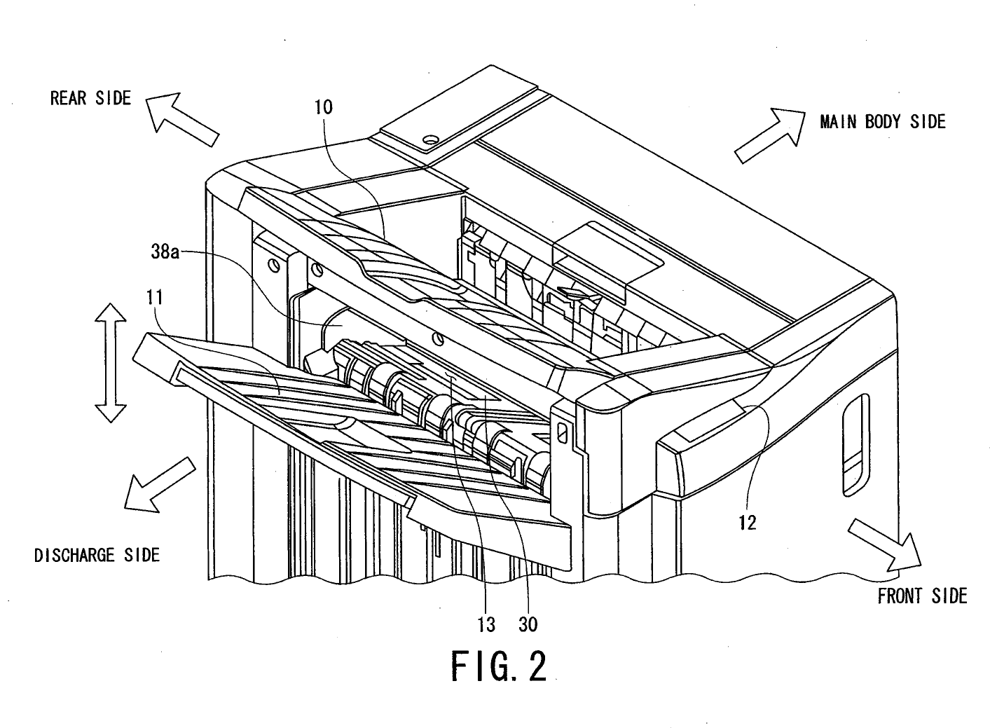

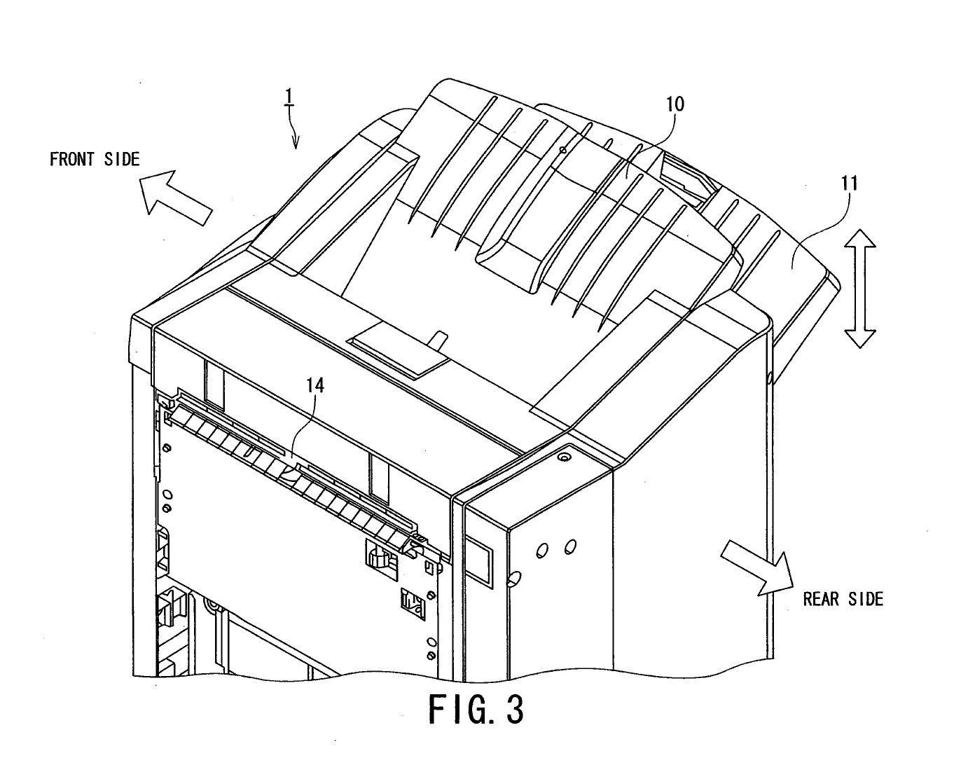

FIGS. 2 and 3 are enlarged perspective views of the upper part of the sheet finishing apparatus 1. FIG. 2 is a diagram viewed in the same direction as that of FIG. 1, and FIG. 3 is a diagram viewed (from the main body 2 side) in the reverse direction to that of FIG. 2.

As indicated by the outline type arrows of FIG. 2, a direction in which sheets or a bundle of sheets is discharged is referred to as a discharge side, a direction in which the main body 2 is installed is referred to as a main body side, the right side as viewed from the discharge side to the main body side is referred to as a front side, and the left side is referred to as a rear side.

A discharge opening 13 is provided between the fixed tray 10 and the movable tray 11 such that sheets and a bundle of sheets stacked in the movable tray 11 are discharged from the discharge opening 13. In the manual stapling mode, a user manually inserts a bundle of sheets into the discharge opening 13, and the bundle of sheets is bound with staples by a stapler 40 provided in the corner of the discharge opening 13.

At the lower part of the discharge opening 13, a processing tray 30 that will be described later is provided. Transverse alignment plates 38a and 38b are provided on the rear side and the front side of the processing tray 30, respectively. In FIG. 2, only the transverse alignment plate 38a on the rear side is shown.

At the upper part of the front side of the sheet finishing apparatus 1, an operation display unit 12 is provided. By operating the operation display unit 12 by the user, the typical operation modes are switched to the manual stapling mode. In addition, in the operation display unit 12, guidance for assisting an operation performed in the manual stapling mode is displayed.

The sheets printed by the main body 2 are input to the sheet finishing apparatus 1 from an intake opening 14 illustrated in FIG. 3.

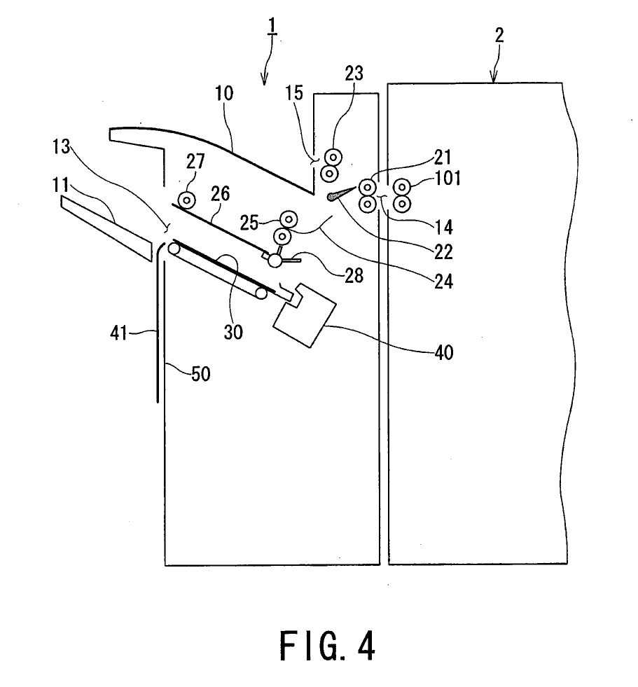

FIG. 4 is a cross-sectional view schematically illustrating the main internal configuration of the sheet finishing apparatus 1 viewed from the front side.

At a position opposed to an outlet roller 101 of the main body 2, an inlet roller 21 is provided, and on the downstream side thereof, a gate flap 22 is provided. A fixed tray roller 23 is provided above the gate flap 22. A carriage guide plate 24 which is bent downward and a carrying roller 25 are provided below the gate flap 22, and in front of the carrying roller 25, a standby tray 26 is provided.

As illustrated in FIG. 4, the standby tray 26 is inclined so that the height of the main body side end thereof is lower than that of the discharge side end. A buffer roller 27 is provided in the vicinity of the front end on the discharge side of the standby tray 26. On the other hand, a paddle 28 is provided in the vicinity of the main body side of the standby tray 26.

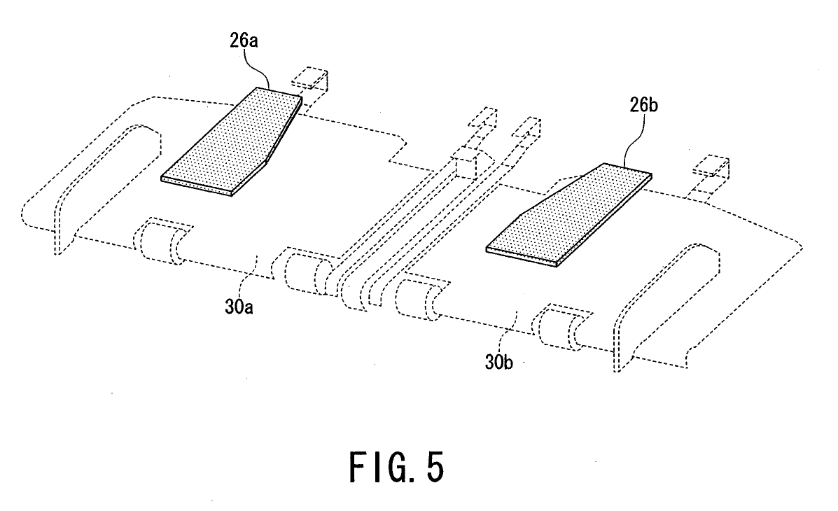

FIG. 5 is a perspective view schematically illustrating the structure of the standby tray 26. In addition to the standby tray 26 hatched in FIG. 5, the processing tray 30 provided below the standby tray 26 is indicated by broken lines. The standby tray 26 is constituted by a standby tray 26a on the rear side and a standby tray 26b on the front side, that is, two standby trays which are able to open and close in front and rear directions as described below by a drive mechanism (not shown).

The processing tray 30 is disposed below the standby tray 26. Similar to the standby tray 26, the processing tray 30 is also inclined so that the height of the main body side end is lower than that of the discharge side end. A shutter 41 is provided between the processing tray 30 and the movable tray 11 along an outer wall 50 of the discharge side of the sheet finishing apparatus 1.

As shown in FIG. 4, the shutter 41 is movable upward and downward, and as described later, is lifted when sheets are directly discharged to the movable tray 11 from the standby tray 26 to close an opening portion between the standby tray 26 and the processing tray 30 in the middle of the discharge opening 13. The stapler 40 is disposed in front of the main body side of the processing tray 30.

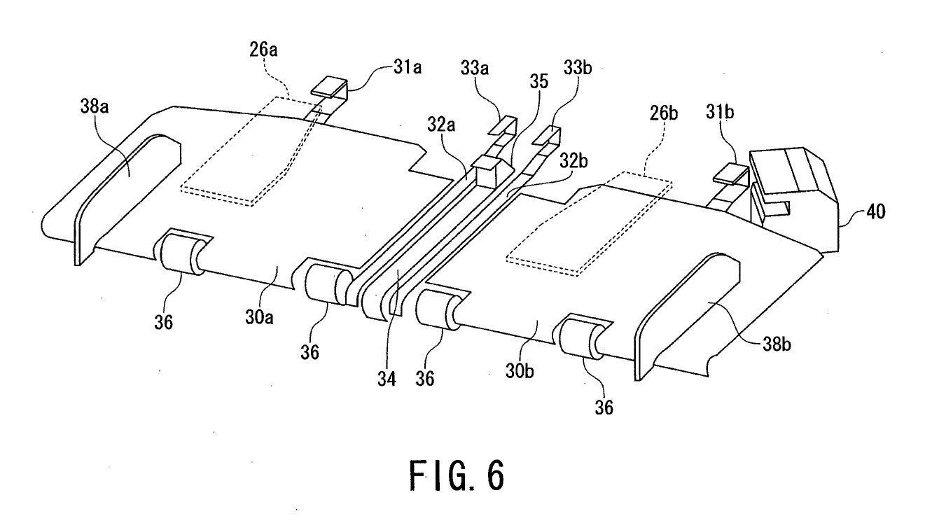

FIG. 6 is a perspective view illustrating the configuration of the processing tray 30 and the vicinity thereof. The processing tray 30 is divided into two processing trays 30a and 30b on the rear side and the front side by the center line. End portions of the main body sides of the processing trays 30a and 30b are respectively provided with rear stoppers 31a and 31b, and end portions of the discharge sides thereof are provided with four sheet bundle carrying rollers 36.

The divided portion of the processing tray 30 is provided with a bundle claw belt 34 and eject belts 32a and 32b adjacently on both sides thereof.

A bundle claw 35 is fixed to the outer periphery of the bundle claw belt 34. The bundle claw belt 34 continuously rotates so that the bundle claw 35 is moved from the main body side to the discharge side on the surface of the processing tray 30 and is returned to the main body side from the discharge side on the rear surface of the processing tray 30.

On the other hand, ejectors 33a and 33b are respectively fixed to the outer peripheries of the eject belts 32a and 32b. The eject belts 32a and 32b are connected to the drive source similar to the bundle claw belt 34 by an electromagnetic clutch (not shown) and thus are substantially in synchronization with the movement of the bundle claw 35 to move the ejectors 33a and 33b to the vicinity of the center portion of the processing tray 30. Thereafter, the electromagnetic clutch is turned off to pull the ejectors 33a and 33b back to a position (the home position of the ejectors) illustrated in FIG. 6 by the elastic force of a spring. That is, the ejectors 33a and 33b reciprocate on the processing tray 30.

The home position of the ejectors 33a and 33b is substantially at the same position as the rear stoppers 31a and 31b.

The processing trays 30a and 30b are respectively provided with the transverse alignment plates 38a and 38b. The transverse alignment plates 38a and 38b are configured to be movable in the rear and front directions by a drive mechanism. In addition, in the manual stapling mode, one or both of the transverse alignment plates 38a and 38b can be manually moved in the rear and front directions.

The single stapler 40 is provided on the main body side of the processing tray 30. The stapler 40 is used for automatically stapling the bundle of sheets printed by the main body 2 and is also used for stapling a bundle of sheets inserted through the discharge opening 13 of the sheet finishing apparatus 1 by the user in the manual stapling mode.

### (2) Operations

### Typical Mode

The typical mode of the sheet finishing apparatus 1 having the above-described configuration will be described first.

The typical mode of the sheet finishing apparatus 1 is roughly classified into two typical modes including a simple stacking mode and a processing stacking mode.

The simple stacking mode is an operation mode of simply discharging and stacking printed sheets as they are, and as a tray to which the sheets are discharged and stacked, the user may select one from the fixed tray 10 and the movable tray 11. The movable tray 11 is slowly lowered as the number of sheets stacked increases and thus can stack a large number of sheets (for example, 2,000 sheets or more). Accordingly, when the number of printed sheets is great, the movable tray 11 is selected by the user as a discharge destination.

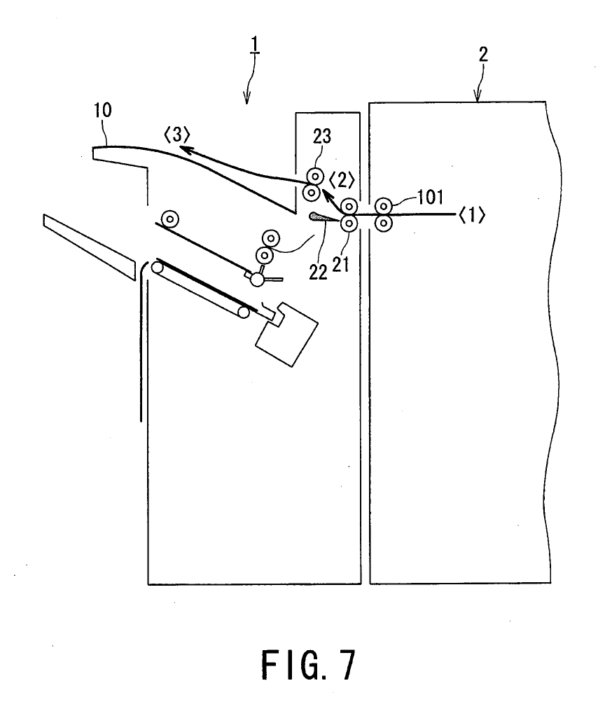

FIG. 7 is a diagram showing a flow of a sheet in the simple stacking mode when the discharge destination is the fixed tray 10. When the fixed tray 10 is selected, the gate flap 22 is moved to a position inclined upward from the inlet roller 21 toward the fixed tray roller 23 as illustrated in FIG. 7. A sheet printed by the main body 2 <1> is pulled by the inlet roller 21 of the sheet finishing apparatus 1 from the outlet roller 101, is then moved upward along the gate flap 22 <2>, is discharged from the fixed tray roller 23 to the fixed tray 10, and is sequentially stacked here <3>.

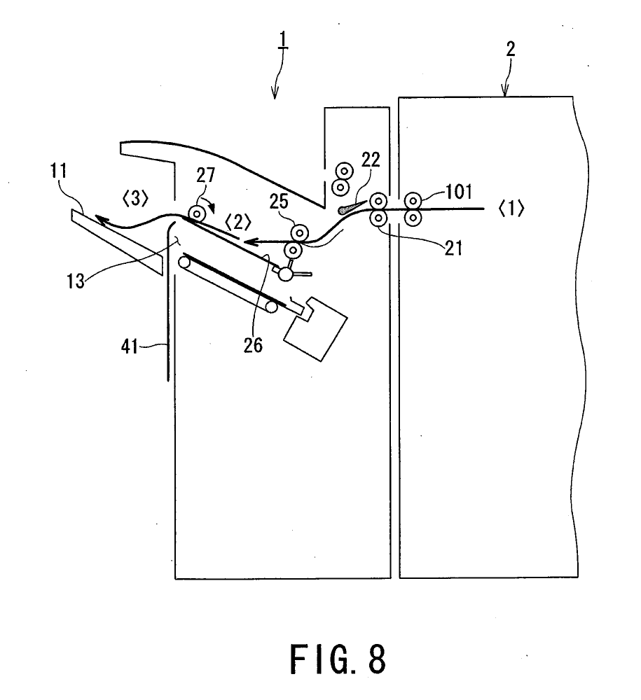

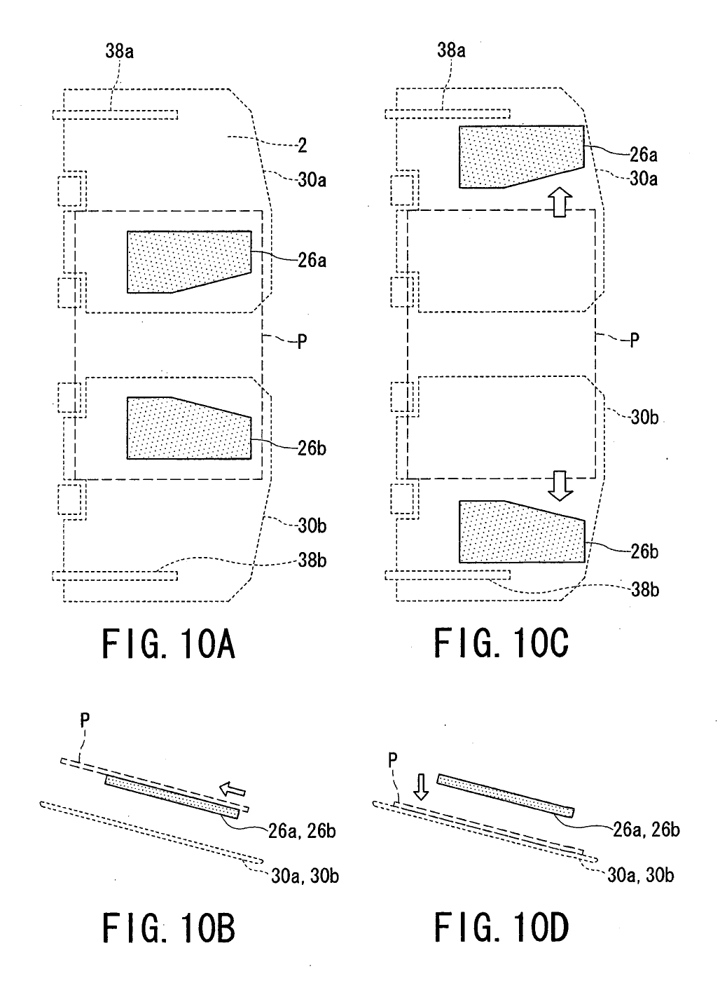

FIG. 8 is a diagram showing a flow of a sheet in the simple stacking mode when the movable tray 11 is selected as the discharge destination. When the movable tray 11 is selected, the gate flap 22 is moved to a position inclined downward from the inlet roller 21 to the carrying roller 25 as illustrated in FIG. 8. A sheet printed by the main body 2 <1> is pulled by the inlet roller 21 of the sheet finishing apparatus 1 from the outlet roller 101, is then moved downward along the gate flap 22, and is temporarily loaded on the standby tray 26 to direct to the buffer roller 27 <2>. Here, the standby trays 26a and 26b are closed (a state shown in FIG. 10A) and thus the sheet does not fall off therefrom to the processing tray 30. In addition, the buffer roller 27 rotates in the direction of the arrow of FIG. 8 while abutting the standby tray 26. Accordingly, the sheet loaded on the standby tray 26 is pulled by the buffer roller 27, is discharged on the movable tray 11, and is sequentially stacked <3>.

In the simple stacking mode when the movable tray 11 is selected, the shutter 41 is lifted, so that the opening portion between the standby tray 26 and the processing tray 30 in the middle of the discharge opening 13 is closed. By the shutter 41, the sheet discharged to or stacked in the movable tray 11 is prevented from being pulled back to the processing tray 30 through the discharge opening 13.

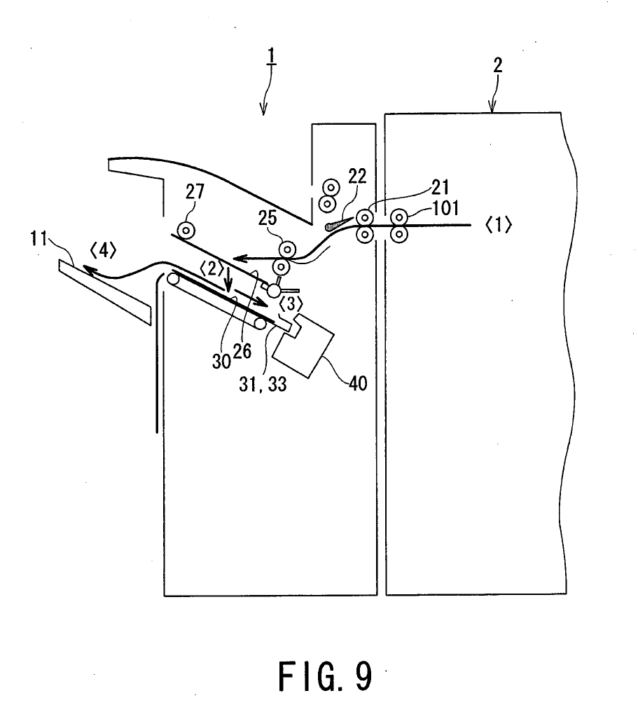

FIG. 9 is a diagram showing a workflow of a sheet in a processing stacking mode. In the processing stacking mode, a sheet or a bundle of sheets are subjected to sorting by discharging and stacking the sheet while being alternately offset to the front side and the rear side or subjected to stapling through one or two points of edges of the bundle of sheets. The processes are performed on the processing tray 30.

A sheet printed by the main body 2 <1> is pulled by the inlet roller 21 of the sheet finishing apparatus 1 from the outlet roller 101, is then moved downward along the gate flap 22, and is temporarily loaded on the standby tray 26. Here, the standby trays 26a and 26b are closed as illustrated in FIG. 10A. When the standby trays 26a and 26b are closed, an interval therebetween is different depending on the sheet size, so that a sheet P with any size does not directly fall off therefrom to the processing tray 30 and is temporarily received by the standby tray 26 (FIG. 10B).

Thereafter, the standby trays 26a and 26b are opened in the front and rear directions as illustrated in FIG. 100, so that the sheet P falls off therefrom to the processing tray 30 (FIG. 10D).

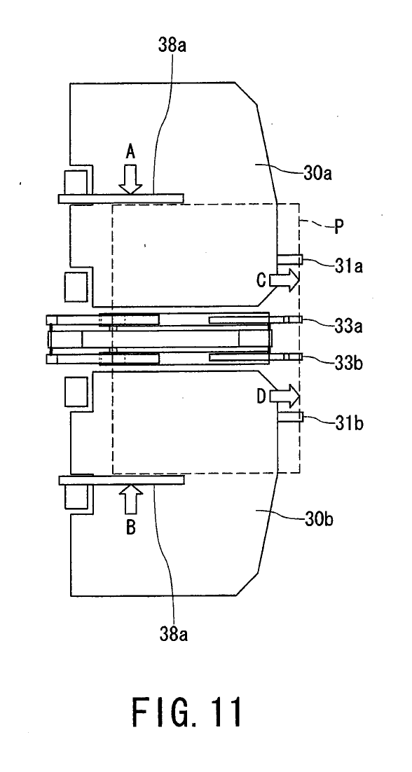

A predetermined number of sheets are stacked on the processing tray 30 and are subjected to longitudinal alignment and transverse alignment as illustrated in FIG. 11. The longitudinal alignment is performed by rotating the sheet bundle carrying roller 36 in the reverse direction to that during discharging, rotating the paddle 28 in FIG. 4 counterclockwise, and pressing the rear edge of the sheet P against the rear stopper 31a and 31b or the ejectors 33a and 33b (the arrows C and D of FIG. 11).

On the other hand, the transverse alignment is performed by pressing the transverse alignment plates 38a and 38b against the edges of the both sides of the sheet P (the arrows A and B of FIG. 11).

The sorting is performed by alternately offsetting the bundle of sheets after being subjected to the longitudinal alignment to the front side and the rear side in order to process the positions for the transverse alignment.

The stapling is performed using the stapler 40 after the longitudinal alignment and the transverse alignment are finished.

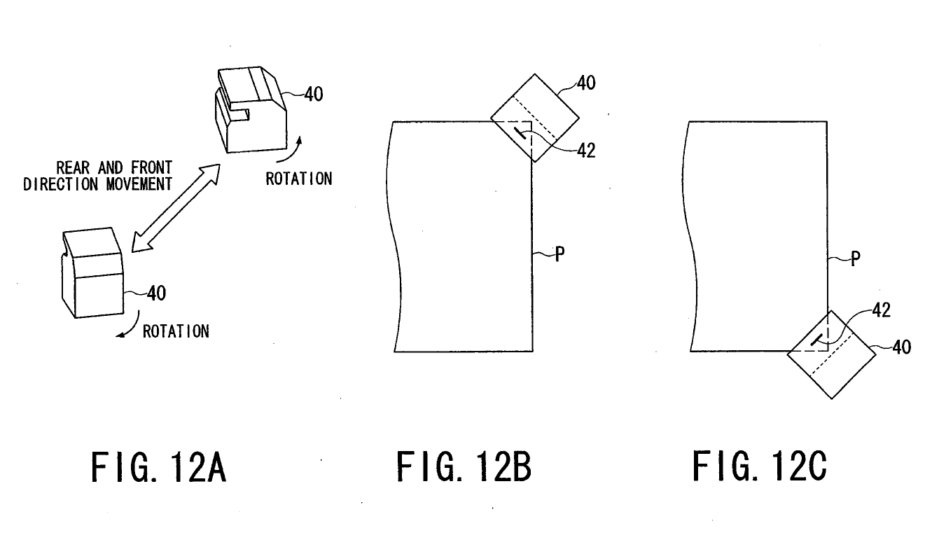

FIGS. 12A to 12C are diagrams for explaining the stapling for binding the rear edge of the sheet P through one point. The stapler 40 is configured to be movable between the front side and the rear side as illustrated in FIG. 12A, and is rotatable at about 45 degrees at the end of the front side and the end of the rear side. FIG. 12B is a diagram showing a positional relationship between the stapler 40 and the sheet P when the rear side of the rear edge of the sheet P is bound with a staple 42 through one point, and FIG. 12C is a diagram showing a positional relationship between the stapler 40 and the sheet P when the front side of the rear edge of the sheet P is bound through one point. The side to be bound can be set by the user through an operation unit (not shown) of the main body 2.

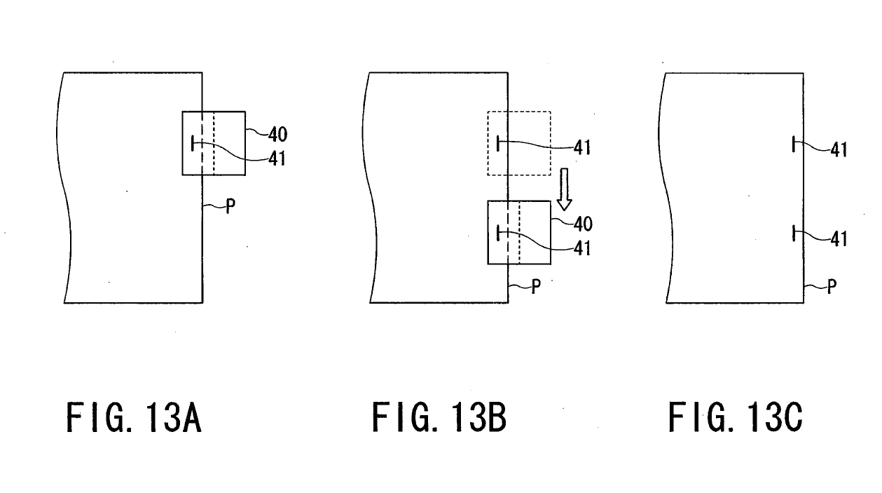

FIGS. 13A to 13C are diagrams for explaining the stapling for binding the rear edge of the sheet P through two points. As illustrated in FIGS. 13A and 13B, the stapler 40 drives a staple 41, for example, at a position close to the rear side of the rear edge of the sheet therethrough in parallel, then moves to the front side in parallel by an interval between staples, and drives a second staple 41. As a result, as illustrated in FIG. 13C, the two points at the rear edge of the sheet P are bound with the staples 41.

The interval between the two staples 41 is typically common in any sheet size. However, a movement distance from the initial position (home position) of the stapler to a position where a staple is initially driven is different depending on the sheet size. Thus, the sheet finishing apparatus 1 receives information on the sheet size, which is set by a user or detected by the main body 2, from the main body 2 and determines the movement distance from the home position.

### (3) Manual Stapling Mode

### First Embodiment

The sheet finishing apparatus 1 has the manual stapling mode. The typical mode and the manual stapling mode are switched by, for example, a switch in the operation display unit 12 of the sheet finishing apparatus 1. In addition, in the manual stapling mode according to the first embodiment, it is possible to select a binding position from the front side and the rear side when the rear edge of the bundle of sheets P is bound at one point. The selection is performed through the operation display unit 12.

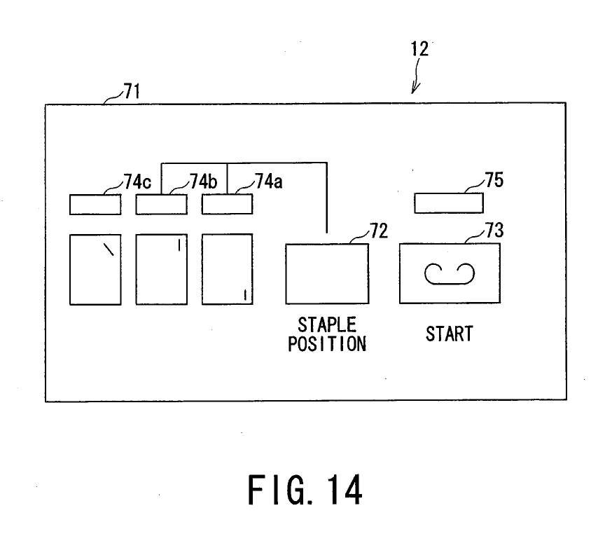

FIG. 14 illustrates an example of operating keys and displays of the operation display unit 12 used in the manual stapling mode. The operation display unit 12 is arranged on the upper front side of the sheet finishing apparatus 1. As shown in FIG. 14, on the panel 71 of the operation display unit 12, there are provided a staple position key 72 and a start key 73. Display 74a and 74b is LEDs which turn on in response to the operation of the staple position key 72. Display 74a and 74b indicate stapling positions which are each correspond to indications arranged below. Turning-on of a display 74c indicates that a corner of the bundle of the sheets P is inserted into the stapler 40 to be stapled, as shown in FIG. 12B, in a manual stapling mode.

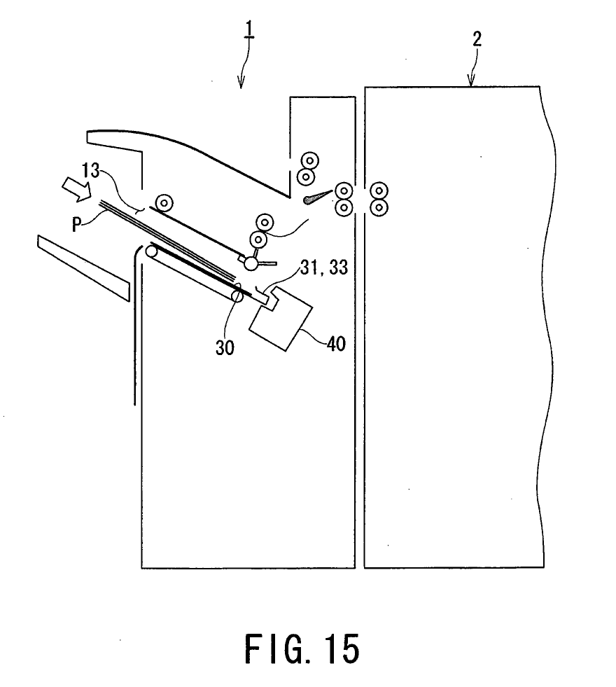

After performing such operations, the user inserts the bundle of sheets P through the discharge opening 13 as illustrated in FIG. 15. Here, when one-point binding on the rear side is selected, the rear edge of the bundle of sheets P is hit by the rear stopper 31 (or the ejector 33) while the transverse alignment plate 38a on the rear side is pressed against the side edge of the rear side of the sheet P. On the other hand, when one-point binding on the front side is selected, the rear edge of the bundle of sheets P is hit by the rear stopper 31 (or the ejector 33) while the transverse alignment plate 38b on the front side is pressed against the side edge of the front side of the sheet P. When the above operations are completed, the start key 73 blinks, for example. When the start key 73 is pressed, stapling processing (here, manual stapling processing) has started, while display 75, which may be LED as well, being turned on. The start key 73 turns on after the stapling processing has completed.

Guidance display for the manual stapling mode similar to the display shown in FIG. 14 may be displayed on the control panel 5 of the main body 2, and the control panel 5 may be configured to accept operations similar to the above mentioned operations.

However, in general, it is difficult for light to travel to the inside of the discharge opening of the sheet finishing apparatus. Particularly, recently, for the purpose of energy saving or the like, there are more and more situations where unnecessary lighting is discouraged on work in the office, so that there is a high possibility that insufficient brightness is ensured at the inside of the discharge opening of the sheet finishing apparatus and thus the inside of the discharge opening is typically dark. Accordingly, even though the user tries to insert the bundle of sheets P to the inside of the discharge opening 13 and align the corner of the bundle of sheet P with the position of the stapler, accurate position alignment cannot be achieved. In addition, before the user is accustomed to using the machine, there are possibilities that the user cannot perform stapling at all or makes mistakes in stapling such as stapling at an unintended position. Further, since the inside of the discharge opening 13 is dark, the existence of the transverse alignment plates 38a and 38b cannot be recognized at all, and there may be a case where stapling is performed without completely aligning the side edge of the bundle of sheets P with the transverse alignment plates 38a and 38b.

Thus, in the sheet finishing apparatus 1 according to the first embodiment, in order to eliminate or reduce such mistakes in stapling, the transverse alignment plates 38a and 38b are configured to emit light, or the transverse alignment plates 38a and 38b are provided with fluorescence, thereby enhancing visibility of the transverse alignment plates 38a and 38b.

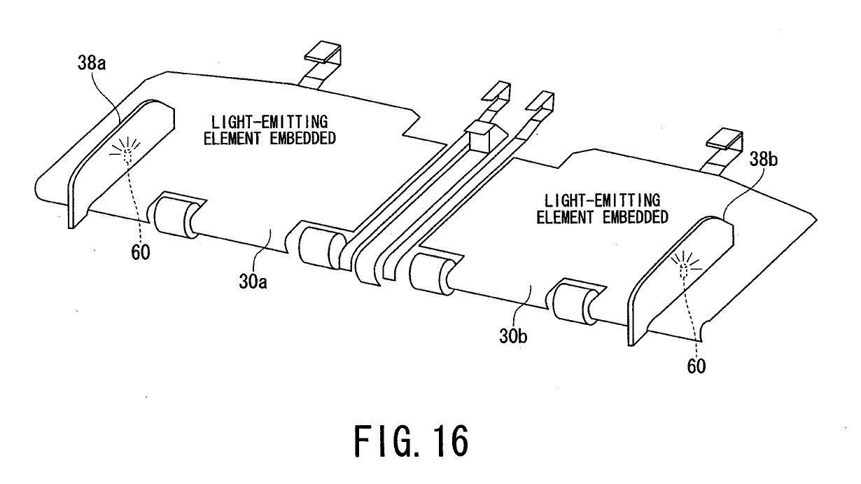

For example, as illustrated in FIG. 16, light-emitting elements 60 such as LEDs are embedded in the transverse alignment plates 38a and 38b. In this case, it is preferable that the transverse alignment plates 38a and 38b be made of a material with high light transmitting property so as to cause light from the light-emitting elements 60 sufficiently reach the outside. For example, a transparent acrylic plate or the like is preferable.

In addition, with regard to the light-emitting element 60, it is preferable that from the viewpoint of energy saving or in order to prevent light from unnecessarily leak, the light-emitting element 60 be configured to emit light only when the manual stapling mode is set and not to emit light in the other modes.

The light-emitting elements 60 are not necessarily embedded in the transverse alignment plates 38a and 38b, and may also be fixed to the outsides of the transverse alignment plates 38a and 38b at positions that do not cause problems during the transverse alignment. In this case, the transverse alignment plates 38a and 38b do not need to be provided with light transmitting property and may be made of a resin with no light transmitting property.

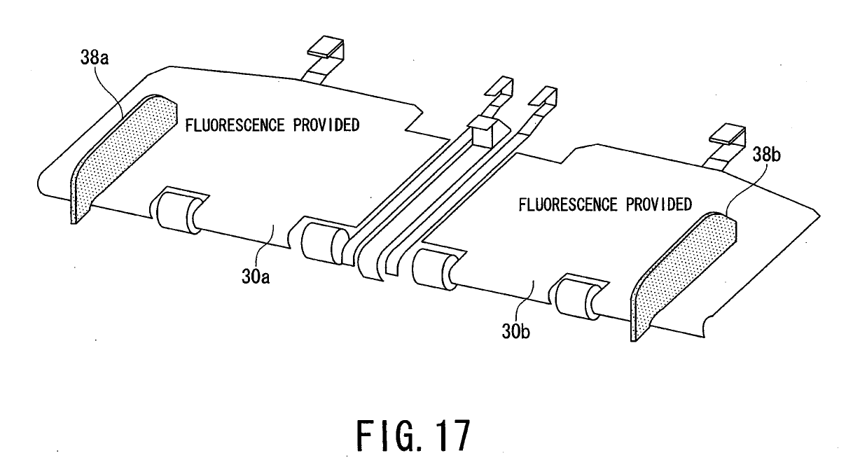

In addition, as illustrated in FIG. 17, instead of embedding the light-emitting elements 60, the transverse alignment plates 38a and 38b may exhibit fluorescence by applying a fluorescent paint or the like onto the transverse alignment plates 38a and 38b.

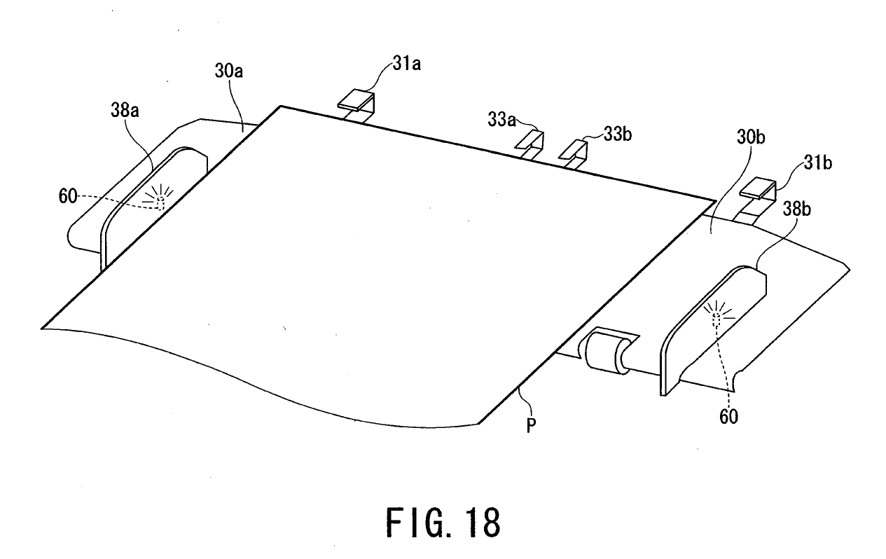

As such, by giving light-emitting property and fluorescence to the transverse alignment plates 38a and 38b, as illustrated in FIG. 18, the bundle of sheets P can be easily aligned with the transverse alignment plates 38a and 38b, and moreover, visibility of the rear stoppers 31a and 31b and the ejectors 33a and 33b disposed in the corner of the processing tray 30 can be enhanced. Therefore, even when the lighting around the sheet finishing apparatus 1 is dark, mistakes in stapling can be reduced, thereby enhancing operability of the manual stapling mode.

In addition, when the light-emitting elements 60 are embedded, light-emitting colors of the rear side and the front side thereof may be different from each other. For example, the red light-emitting element 60 is embedded in the rear-side transverse alignment plate 38a, and the blue light-emitting element 60 is embedded in the front-side transverse alignment plate 38b.

In addition, for example, when the one-point binding of the rear side is performed, the same color as the light-emitting color of the rear side (in this case, red) may be displayed on the operation display unit 12, and guidance to urge the side edge of the rear side of the bundle of sheets to be aligned with the rear-side transverse alignment plate 38a may be displayed.

By contrast, when the one-point binding of the front side is performed, the same color as the light-emitting color of the front side (in this case, blue) may be displayed on the operation display unit 12, and guidance to urge the side edge of the front side of the bundle of sheets to be aligned with the front-side transverse alignment plate 38b may be displayed.

Accordingly, the guidance in relation to the light-emitting colors of the transverse alignment plates 38a and 38b is displayed, so that the operability of the manual stapling mode can further be enhanced.

In addition, when one or both of the transverse alignment plates 38a and 38b are manually moved to the rear side or the front side to be aligned with the side edges of the sheet, operability can further be enhanced when the guidance is displayed on the operation display unit in relation to the light-emitting colors of the moved transverse alignment plates 38a and 38b.

### (4) Manual Stapling Mode

### Second Embodiment

When the two-point binding is to be performed at symmetrical positions with respect to the center of the rear edge of a bundle of sheets with various sizes, information on the sheet size is needed. For the case in which the sheet printed by the main body 2 is automatically subjected to the two-point binding, it is possible to input, from the main body 2, information on the sheet size detected by the main body 2 or set to the main body 2 by a user. However, in a manual stapling mode according to the related art, the one-point binding is mainly performed, so that the two-point binding of the bundle of sheets with various sizes cannot be properly performed.

When the two-point binding is performed in the manual stapling mode, an operation of inputting a sheet size by the user is needed. However, this operation is too much of a bother. Moreover, an operation of aligning the transverse alignment plates 38a and 38b with the bundle of sheets is needed in addition to the operation of inputting the sheet size.

Thus, in the manual stapling mode of the sheet finishing apparatus 1 according to the second embodiment, a measure for simultaneously performing detection of the sheet size and alignment with the transverse alignment plates 38a and 38b is provided.

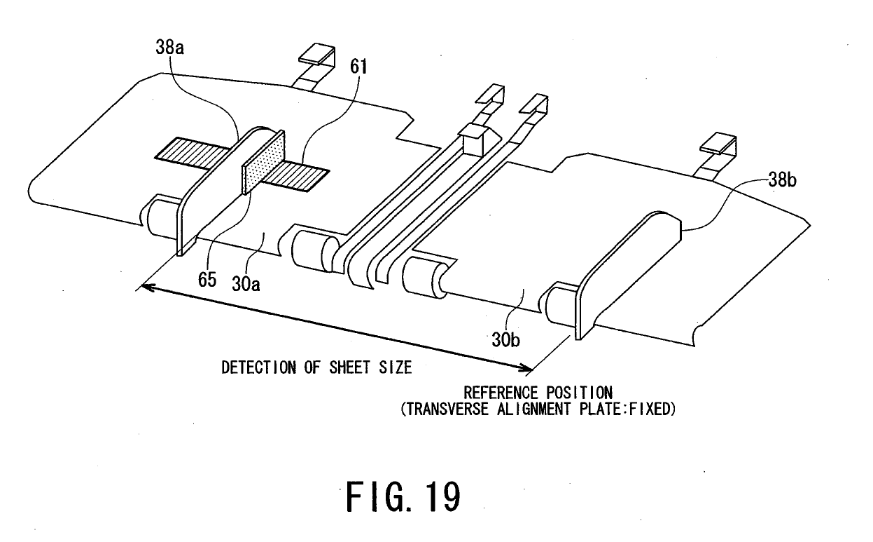

In the second embodiment, as illustrated in FIG. 19, a unit for detecting an interval in the rear and front direction of the transverse alignment plates 38a and 38b on the processing tray 30 is provided.

In the manual stapling mode, it is possible to manually move one or both of the transverse alignment plates 38a and 38b in the rear and front direction. FIG. 19 illustrates an example of a configuration in which the position of the front-side transverse alignment plate 38b is fixed and the rear-side transverse alignment plate 38a is movable.

In this case, the rear-side transverse alignment plate 38a which is movable is configured to include a conduction plate 65 having electrical conductivity. The conduction plate 65 is fixed to the transverse alignment plate 38a so as to move in the rear and front direction integrally with the transverse alignment plate 38a.

In a movable range of the transverse alignment plate 38a on the rear-side processing tray 30a, a sheet size detecting substrate 61 is provided.

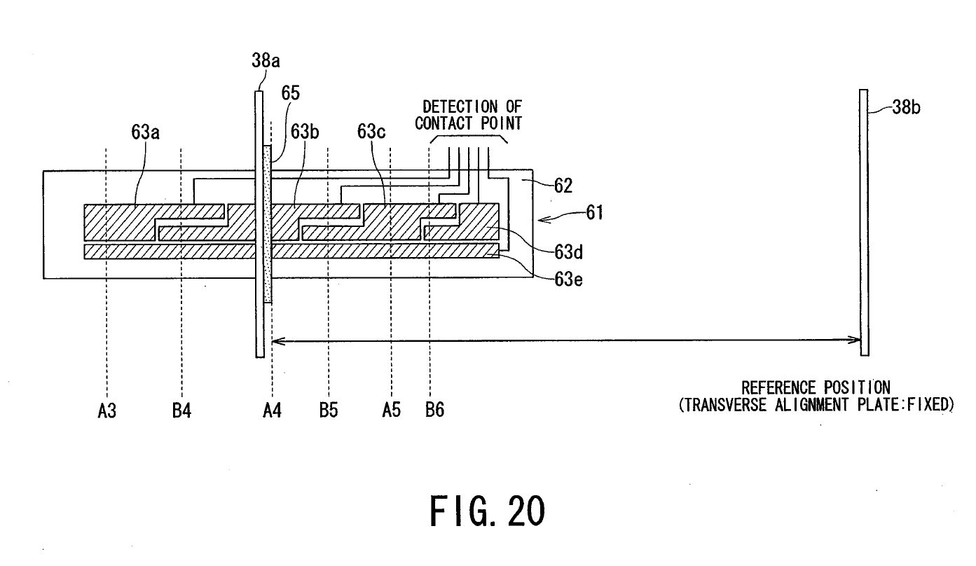

FIG. 20 is a plan view of an example of the sheet size detecting substrate 61 viewed from above. The sheet size detecting substrate 61 is formed by plating a plurality of patch areas on a rectangular substrate 62 with copper, for example. The patch areas have different shapes from each other and are electrically insulated from each other. In addition, a conduction line is drawn from each of the patch areas to the outside.

The plurality of patch areas on the conduction plate 65 are short-circuited by the conduction plate 65 moving integrally with the transverse alignment plate 38a. The patch region to be short-circuited is determined depending on the movement position of the conduction plate 65 in the rear and front direction. Therefore, the short-circuited or opened state of each patch region is detected by an external contact point detection unit, so that the position of the conduction plate 65, that is, the position of the transverse alignment plate 38a in the rear and front direction can be detected.

Since the position of the front-side transverse alignment plate 38b is fixed, when the front side edge of the bundle of sheets is aligned with the front-side transverse alignment plate 38b, the position of the rear-side transverse alignment plate 38a is moved to align with the rear-side edge of the bundle of sheets and the position of the transverse alignment plate 38a is detected, the size of the bundle of sheets can be simply detected. In addition, by aligning the rear-side transverse alignment plate 38a with the edge of the bundle of sheets, transverse alignment can be simultaneously performed.

As long as the sheet size is detected, it is possible to obtain the movement distance from a reference position of the stapler 40 when the two-point binding is performed.

In the example of the above description, the rear-side transverse alignment plate 38a is moved. However, reversely, the front-side transverse alignment plate 38b may be configured to move while the rear-side thereof is fixed. In this case, the sheet size detecting substrate 61 is provided on the front-side processing tray 30a. Furthermore, the positions of both the transverse alignment plates 38a and 38b may be configured to be detected.

In addition, in the example described above, the position of the transverse alignment plate 38 is detected by the conduction plate 65 and the sheet size detecting substrate 61. However, the invention is not limited to the example, and any units known by those skilled in the art, which are capable of detecting the position of the transverse alignment plate 38 in the rear and front direction on the processing tray 30, can be incorporated into the invention.

As described above, according to the second embodiment, in the manual stapling mode, the two-point binding of the bundle of sheets with various sizes can be easily performed simultaneously with the operations of the transverse alignment.

While certain embodiments have been described, these embodiments have been presented by way of example only, and are not intended to limit the scope of the invention. Indeed, the novel apparatuses and units described herein may be embodied in a variety of other forms; furthermore, various omissions, substitutions and changes in the form of the apparatuses and units described herein may be made without departing from the spirit of the invention. The accompanying claims and their equivalents are intended to cover such forms or modifications as would fall within the scope and spirit of the invention.

What is claimed is:

1. A sheet finishing apparatus comprising:
a discharge, opening from which a sheet is discharged in an operation mode other than a manual stapling mode, and through which a bundle of sheets is manually inserted inside the discharge opening in the manual stapling mode;
a stapler that is disposed inside the discharge opening and binds with staples the bundle of sheets inserted from the discharge opening; and
a transverse alignment plate that aligns the sheet discharged from the discharge opening along a sheet discharge direction in the operation mode other than the manual stapling mode, and guides the bundle of sheets inserted from the discharge opening to a position of the stapler in the manual stapling mode, the transverse alignment plate emitting light or exhibiting fluorescence.

2. The apparatus according to claim 1, wherein the transverse alignment plate does not emit light in the operation mode other than the manual stapling mode and emits light in the manual stapling mode.

3. The apparatus according to claim 2, wherein the transverse alignment plate has a light-emitting element embedded therein.

4. The apparatus according to claim 3, wherein the light-emitting element is formed of a transparent material.

5. The apparatus according to claim 1, wherein the transverse alignment plate is constituted by a front transverse alignment plate disposed on a front side of the sheet finishing apparatus and a rear transverse alignment plate disposed on a rear side thereof.

6. The apparatus according to claim 5, wherein at least one of the front and rear transverse alignment plates is able to slide in a direction perpendicular to the sheet discharge direction of the bundle of sheets.

7. The apparatus according to claim 4, wherein the transverse alignment plate is constituted by a front transverse alignment plate disposed on a front side of the sheet finishing apparatus and a rear transverse alignment plate disposed on a rear side thereof.

8. The apparatus according to claim 7, wherein at least one of the front and rear transverse alignment plates is able to slide in a direction perpendicular to an insertion direction of the bundle of sheets.

9. The apparatus according to claim 8, wherein a color of a front light-emitting element embedded in the front transverse alignment plate and a color of a rear light-emitting element embedded in the rear transverse alignment plate are different from each other.

10. The apparatus according to claim 9, further comprising a display unit,
wherein the display unit displays operation guidance for the manual stapling mode to be associated with the color of the front light-emitting element and the color of the rear light-emitting element.

11. The apparatus according to claim 10, wherein the display unit displays the color of the front light-emitting element and displays guidance to urge one edge of the bundle of sheets that is parallel to an insertion direction of the bundle of sheets to be aligned with the front transverse alignment plate, and thereafter, the display unit displays the color of the rear light-emitting element and performs displaying to urge the rear transverse alignment plate to move to the opposite edge of the bundle of sheets.

12. The apparatus according to claim 10, wherein the display unit displays the color of the rear light-emitting element and displays guidance to urge one edge of the bundle of sheets that is parallel to an insertion direction of the bundle of sheets to be aligned with the rear transverse alignment plate, and thereafter, the display unit displays the color of the front light-emitting element and performs displaying to urge the front transverse alignment plate to move to the opposite edge of the bundle of sheets.

13. The apparatus according to claim 5, wherein the stapler binds the bundle of sheets with staples through two points at the edges of the bundle of sheets, which are perpendicular to the insertion direction of the bundle of sheets that is interposed between the front and rear transverse alignment plates.

14. The apparatus according to claim 7, wherein the stapler binds the bundle of sheets with staples at two points of the edges of the bundle of sheets, which are perpendicular to the insertion direction of the bundle of sheets interposed between the front and rear transverse alignment plates.

15. An image forming apparatus comprising:
a scanner that reads an original document;
a printer that prints an image read by the scanner on a sheet;
a discharge opening from which the sheet printed by the printer is discharged in an operation mode other than a manual stapling mode, and into which a bundle of sheets is manually inserted in the manual stapling mode;
a stapler that is disposed inside the discharge opening and binds the bundle of sheets inserted into the discharge opening with staples; and
a transverse alignment plate that aligns the sheet discharged from the discharge opening in a sheet discharge direction in the operation mode other than the manual stapling mode, and guides the bundle of sheets inserted from the discharge opening to a position of the stapler in the manual stapling mode, the transverse alignment plate emitting light or exhibiting fluorescence.

16. The apparatus according to claim 15, wherein the transverse alignment plate does not emit light in the operation mode other than the manual stapling mode and emits light in the manual stapling mode.

17. The apparatus according to claim 16, wherein the transverse alignment plate has a light-emitting element embedded therein.

18. The apparatus according to claim 17, wherein the light-emitting element is formed of a transparent material.

19. The apparatus according to claim 15, wherein the transverse alignment plate is constituted by a front transverse alignment plate disposed on a front side of the sheet finishing apparatus and a rear alignment plate disposed on a rear side thereof.
